(19) United States
(12) Patent Application Publication
(10) Pub. No.: US 2007/0137790 A1
(43) Pub. Date: Jun. 21, 2007

(54) Process for manufacturing a laminate

(76) Inventor: Hans-Rudolf Nageli, Neuhausen (CH)

Correspondence Address: FISHER, CHRISTEN & SABOL, 1725 K STREET, N.W., SUITE 1108, WASHINGTON, DC, 20006, US

(21) Appl. No.: 11/640,175

(22) Filed: Dec. 18, 2006

(30) Foreign Application Priority Data
Dec. 21, 2005 (EP) 05 405 715.3

(51) Int. Cl. C04B 37/00

(52) U.S. Cl. 156/325

(57) ABSTRACT

A process for manufacturing a laminate (48) out of two film-shaped substrates (44, 46) as outer layers joined together by means of adhesive layers (34, 38) and at least one functional intermediate layer (36) is such that a first substrate (44) is coated, by liquid film coating using curtain coating or slide coating, with a multi-layer liquid film comprising at least two outer adhesive layers (34, 38) and at least one functional intermediate layer (36) and optionally at least one additional intermediate layer (35, 37) and is subsequently bonded to the second substrate (46). The process makes it possible to manufacture laminates with barrier properties in a simple and cost-favourable manner.

The invention relates to a process for manufacturing a laminate comprising two film-shaped substrates as outer layers joined to at least one functional intermediate layer by means of adhesive layers.

The present day lamination methods used to manufacture packaging are based on individual layers that are deposited by roll-coating. The production of laminates with barrier layers is such that three or more layers are bonded together, for which a corresponding number of adhesive coating stations is required. Optimised adhesive layers require compositions that are often expensive and, if necessary, additional primers have to be employed to obtain optimum bonding. The application of these primers requires either separate passes through the coating units or additional coating stations.

To manufacture multi-layer photographic films and papers, for many years now use has been made of a liquid film coating method known as “curtain coating”. In that process several layers are deposited in free-fall simultaneously from a slit-shaped nozzle onto a moving strip of material.

Proposals have already been made to apply curtain coating technology to the coating of papers and to the production of plastic composite materials.

Described in WO-A-0154828 is a method for manufacturing a multi-layer packaging laminate with at least two superimposed layers, in which process two or more layers are deposited in the liquid state by curtain coating onto a substrate of a—possibly pre-coated—paper, cardboard or plastic film and subsequently dried. The liquid film coatings comprise barrier layers, intermediate layers acting as spacers, oxygen scavenger layers and hot-sealing layers.

Known from U.S. Pat. No. 6,845,599 is a liquid-film coating method which is an alternative to curtain viz., “slide coating”. In this alternative coating method several layers are simultaneously deposited coming from a slit-shaped nozzle and a nozzle slide face directly onto a substrate passing the run-out edge of the nozzle slide face.

The object of the present invention is to provide a process of the kind mentioned at the start in which laminates with functional intermediate layers such as e.g. barrier layers can be manufactured in a simple and cost-favourable manner.

That objective is achieved by way of the invention in that a first substrate is coated by liquid-film coating using curtain-coating or slide-coating with a multi-layer liquid film comprising at least two outer lying adhesive layers and at least one functional intermediate layer and, subsequently bonded to the second substrate.

Functional intermediate layers preferably feature at least one barrier function involving preventing the penetration of oxygen, carbon dioxide, aromas and/or water vapour by diffusion, or inhibiting the transmission of ultraviolet radiation and the scavenger function in which oxygen, water vapour and aromas are absorbed.

Functional intermediate layers with barrier properties against penetration of oxygen, carbon dioxide, aromas and/or water vapour are based e.g. on polyvinyl alcohol (PVOH), ethylene-vinyl-alcohol (EVOH), cross-linking acrylates, polyamides, PVDC (polyvinylidenchloride), epoxy-amine, fluor-polymer nanocomposites and/or layer silicates.

Functional intermediate layers with barrier properties against the penetration of ultraviolet radiation contain e.g. organic absorbers or inorganic particles.

Functional intermediate layers with a scavenger function contain e.g. inorganic or organic filler materials or molecular sieves as absorber material. Inorganic fillers are e.g. particles of oxides belonging to the alkali and alakali-earth metals such as e.g. calcium oxide (CaO).

Each of the adhesive layers is preferably functionally optimised with respect to the surface of its neighbouring substrate.

By “functionally optimised” is to be understood that the composition of adhesive used for the adhesive layers is made to suit the chemical and/or physical properties of the substrate neighbouring on the adhesive layers such that optimum adhesion is achieved between each pair viz,. substrate/adjacent adhesive layer.

This way and in a simple manner two substrates with different surface properties can be coated with an adhesive which is optimised in each case with respect to the bonding required for each substrate.

The compositions of adhesive that are optimised specifically for a given substrate are often expensive products. For that reason in some cases it may be necessary to provide a liquid film which, apart from the adhesive layers, exhibits at least one intermediate layer as additional volume, whereby the thickness of the adhesive layer is less than the thickness of the intermediate layer. The thickness of the adhesive layers usefully amounts to about 1 to 30%, preferably 1 to 10% of the thickness of the intermediate layers.

The intermediate layers are preferably of a cost favourable material such as e.g. a urethane-based adhesive, in particular a standard urethane adhesive such as e.g. aromatic or aliphatic isocyanates.

The adhesives may e.g. be made up of polyether, polyester or polybutadienepolyols, may be acrylic or epoxy based, or made up of a combination of the mentioned adhesives.

The layers of liquid films may be solvent-based, solvent-free or water-based. Solvent-free coating fluids are preferred as they do not require the normal drying step.

Substrates which may be employed are plastic films e.g. of polyethylenetherephthalate (PET). Polyethylene (PE), polypropylene (PP), polyamide (PA), paper or a combination of at least two of the materials mentioned.

Further advantages, features and details of the invention are revealed by way of the invention by way of the following description of preferred exemplified embodiments and by way of the drawing; these are shown schematically in

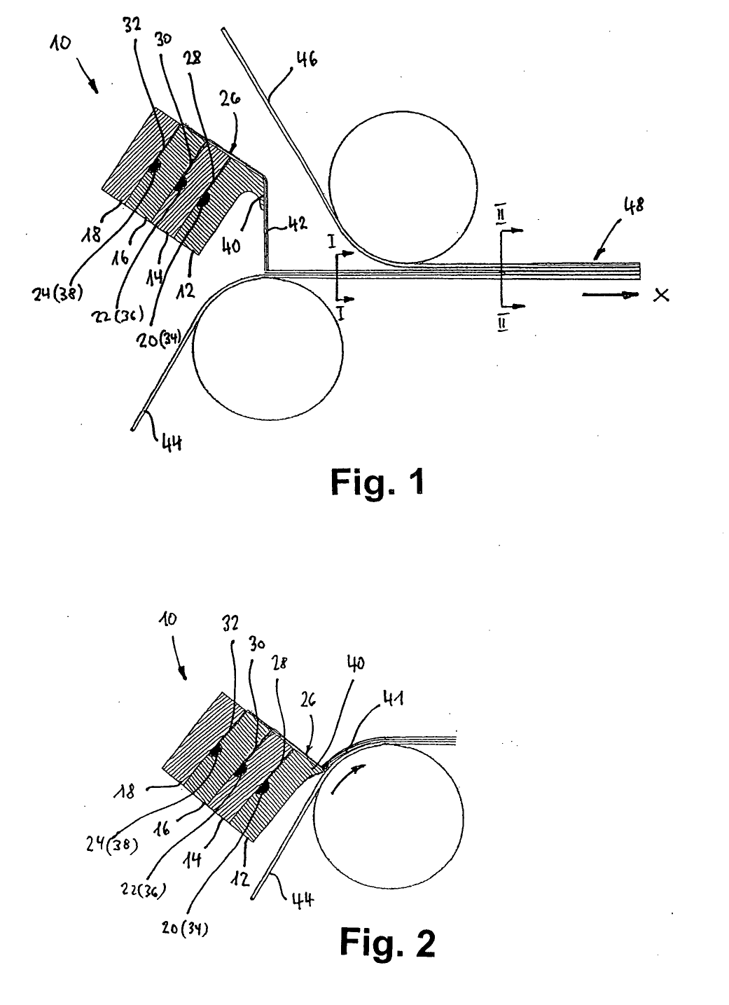

FIG. 1 the procedure involved when joining two substrates by means of curtain coating, shown here in cross-section;

FIG. 2 the slide-coating process, shown here in cross-section, as alternative to the curtain coating process in FIG. 1;

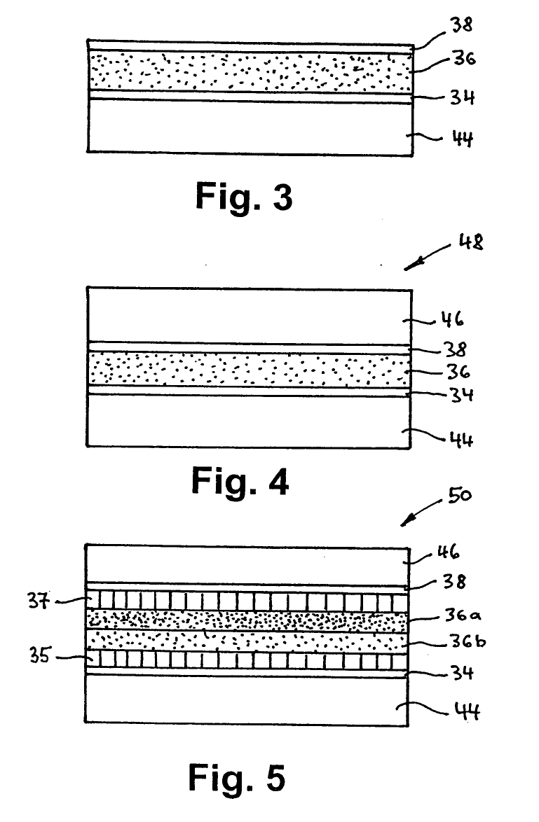

FIG. 3 a cross-section through a detail in FIG. 1 along line I-I;

FIG. 4 a cross-section through a detail in FIG. 1 along line II-II;

FIG. 5 a cross-section through a laminate that can be manufactured using curtain or slide coating.

A nozzle arrangement 10, shown in FIG. 1, of a slide-face coating device—not shown in greater detail—for liquid film coating using curtain coating features four modules 12, 14, 16, 18 lying one on top of the other. Altogether, the in-line modules 12, 14, 16, 18 form three distribution chambers 20, 22, 24 arranges transverse to a strip-movement direction x, whereby each of the distribution chambers 20, 22, 24 features an exit slit 28, 30, 32 terminating at a nozzle slide face 26. The distribution chambers 20, 22, 24 are fed separately and in dosed quantities with coating fluids 34 (adhesive), 36 (functional intermediate layer) 38 (adhesive).

The superimposed coating fluids 34, 36, 38 emerging from the distribution chambers 20, 22, 24 via exit slits 28, 30, 32 onto the nozzle slide face 26 run as a three layer liquid film 42 over a run-off edge 40 on module 12 and form a free-falling curtain.

The three-layer film 42 made up of the coating fluids 34, 36, 38 impinges essentially vertically with the first strip-shaped substrate 44 moving in direction x.

FIG. 2 shows a nozzle arrangement 10 with essentially the same make up as the nozzle arrangement in FIG. 1, whereby the run-off edge 40 is modified to carry out the slide-coating process. Here, the three layer liquid film 41 slides from the run-off edge 40 directly onto the strip-shaped substrate 44 passing the run-off edge 40.

The liquid film 42 in FIG. 1 forms on the surface of the first substrate strip 44 the fluid coating shown in FIG. 3.

As shown in FIG. 1, a second substrate strip 46 is fed in the direction of strip movement x to the first substrate strip 44 which is coated with the coating fluids 34, 36, 38 and is and is adhesively bonded to the coated first strip 44 to give a laminate 48 as shown in FIG. 4

Using the process shown in FIG. 1 it is possible to manufacture e.g. a laminate out of a PET film and a PE film with a barrier layer of PVOH situated between these layers in the following manner. A PET film is coated with a three layer liquid film and the coated PET film subsequently adhesively bonded to a PE film. The three layer liquid film comprises a first urethane, acrylic or epoxy based adhesive layer optimised with respect to the PET surface, a central barrier layer of PVOH and a second urethane, acrylic or epoxy based adhesive optimised with respect to the PE surface.

FIG. 5 shows another example of a laminate 50 with substrates 44, 46 as outer layers which are joined by means of a six-layer liquid film to form a laminate 50 with barrier layer in the inside using curtain coating or slide coating. The six-layer liquid film features two outer adhesive layers 34, 38 each of which is optimised with respect to the surface of the neighbouring substrate. On each of the adhesive layers 34, 38 is an intermediate layer 35, 37 as a filler mass. Situated between the intermediate layers 35, 37 is a barrier layer exhibiting two different functions and made up of two separate layers 36a, 36b.

1. Process for manufacturing a laminate (48) out of two film-shaped substrates (44, 46) as outer layers joined together by means of adhesive layers (34, 38) and at least one functional intermediate layer (36),
wherein,
a first substrate (44) is coated, by liquid film coating using curtain coating or slide coating, with a multi-layer liquid film (42) comprising at least two outer adhesive layers (34, 38) and at least one functional intermediate layer (36) and optionally at least one additional intermediate layer (35, 37) and subsequently bonded to the second substrate (46).

2. Process according to claim 1, wherein the functional intermediate layer/layers features/feature at least one barrier property involving preventing the penetration of oxygen, carbon dioxide, aromas and/or water vapor by diffusion, or inhibiting the transmission of ultraviolet radiation and the scavenger function in which oxygen, water vapor and aromas are absorbed.

3. Process according to claim 2, wherein the functional intermediate layer/layers (36) with barrier action against the passage of oxygen, carbon dioxide, aromas and/or water vapor is/are made up on the basis of PVOH, EVOH, cross-linking acrylics, polyamides, PVDC, epoxy-amine, fluor-polymers, nanocomposites and/or layer silicates.

4. Process according to claim 2, wherein the functional inter-mediate layer/layers (36) with barrier action against the passage of UV-radiation contains/contain organic absorbers and/or inorganic particles.

5. Process according to claim 2, wherein the functional intermediate layer/layers (36) with scavenger function contains/contain inorganic fillers or molecular sieves as absorber material.

6. Process according to claim 1, wherein each of the adhesive layers (34, 38) is optimized with respect to the surface of the neighboring substrate (44, 46).

7. Process according to claim 1, wherein the liquid film features at least one additional intermediate layer (35, 37) providing additional layer volume.

8. Process according to claim 7, wherein the thickness of the adhesive layers (34, 38) is less than the thickness of the intermediate layer (35, 37) providing additional layer volume.

9. Process according to claim 8, wherein the thickness of the adhesive layers (34, 38) amounts to 1 to 30 percent, preferably 1 to 10 percent of the thickness of the intermediate layer (35, 37) providing additional layer volume.

10. Process according to claim 1, wherein the adhesive layers (34, 38) are made up on a urethane basis, in particular polyether, polyester or polybutadienpolyols, are acrylic or epoxy based or combinations of the mentioned adhesives.

11. Process according to claim 7, wherein the intermediate layer (35, 37) providing additional layer volume is a urethane-based adhesive, in particular of aromatic or aliphatic isocyanates.

12. Process according to claim 1, wherein the layers (34, 35, 36, 37, 38) of liquid film are solvent-based, solvent-free or water-based.

13. Process according to claim 1, wherein the substrates (44, 46) are plastic films, paper or a combination of at least two of the aforementioned materials.

14. Process according to claim 2, wherein each of the adhesive layers (34, 38) is optimized with respect to the surface of the neighboring substrate (44, 46).

15. Process according to claim 3, wherein each of the adhesive layers (34, 38) is optimized with respect to the surface of the neighboring substrate (44, 46).

16. Process according to claim 4, wherein each of the adhesive layers (34, 38) is optimized with respect to the surface of the neighboring substrate (44, 46).

17. Process according to claim 5, wherein each of the adhesive layers (34, 38) is optimized with respect to the surface of the neighboring substrate (44, 46).

18. Process according to claim 14, wherein the liquid film features at least one additional intermediate layer (35, 37) providing additional layer volume.

19. Process according to claim 15, wherein the liquid film features at least one additional intermediate layer (35, 37) providing additional layer volume.

20. Process according to claim 16, wherein the liquid film features at least one additional intermediate layer (35, 37) providing additional layer volume.

21. Process according to claim 17, wherein the liquid film features at least one additional intermediate layer (35, 37) providing additional layer volume.

22. Process according to claim 18, wherein the adhesive layers (34, 38) are made up on a urethane basis, in particular polyether, polyester or polybutadienpolyols, are acrylic or epoxy based or combinations of the mentioned adhesives.

23. Process according to claim 19, wherein the adhesive layers (34, 38) are made up on a urethane basis, in particular polyether, polyester or polybutadienpolyols, are acrylic or epoxy based or combinations of the mentioned adhesives.

24. Process according to claim 20, wherein the adhesive layers (34, 38) are made up on a urethane basis, in particular polyether, polyester or polybutadienpolyols, are acrylic or epoxy based or combinations of the mentioned adhesives.

25. Process according to claim 21, wherein the adhesive layers (34, 38) are made up on a urethane basis, in particular polyether, polyester or polybutadienpolyols, are acrylic or epoxy based or combinations of the mentioned adhesives.

26. Process according to claim 8, wherein the adhesive layers (34, 38) are made up on a urethane basis, in particular polyether, polyester or polybutadienpolyols, are acrylic or epoxy based or combinations of the mentioned adhesives.

27. Process according to claim 9, wherein the adhesive layers (34, 38) are made up on a urethane basis, in particular polyether, polyester or polybutadienpolyols, are acrylic or epoxy based or combinations of the mentioned adhesives.

28. Process according to claim 22, wherein the layers (34, 35, 36, 37, 38) of liquid film are solvent-based, solvent-free or water-based.

29. Process according to claim 23, wherein the layers (34, 35, 36, 37, 38) of liquid film are solvent-based, solvent-free or water-based.

30. Process according to claim 24, wherein the layers (34, 35, 36, 37, 38) of liquid film are solvent-based, solvent-free or water-based.

31. Process according to claim 25, wherein the layers (34, 35, 36, 37, 38) of liquid film are solvent-based, solvent-free or water-based.

32. Process according to claim 8, wherein the layers (34, 35, 36, 37, 38) of liquid film are solvent-based, solvent-free or water-based.

33. Process according to claim 9, wherein the layers (34, 35, 36, 37, 38) of liquid film are solvent-based, solvent-free or water-based.

34. Process according to claim 28, wherein the substrates (44, 46) are plastic films, paper or a combination of at least two of the aforementioned materials.

35. Process according to claim 29, wherein the substrates (44, 46) are plastic films, paper or a combination of at least two of the aforementioned materials.

36. Process according to claim 30, wherein the substrates (44, 46) are plastic films, paper or a combination of at least two of the aforementioned materials.

37. Process according to claim 31, wherein the substrates (44, 46) are plastic films, paper or a combination of at least two of the aforementioned materials.

38. Process according to claim 8, wherein the substrates (44, 46) are plastic films, paper or a combination of at least two of the aforementioned materials.

39. Process according to claim 9, wherein the substrates (44, 46) are plastic films, paper or a combination of at least two of the aforementioned materials.
